(19) United States
(12) Patent Application Publication
(10) Pub. No.: US 2020/0314602 A1
(43) Pub. Date: Oct. 1, 2020

(54) GROUP COMMUNICATION SYSTEM II

(71) Applicant: Peiker Holding GmbH, Bad Homburg (DE)

(72) Inventors: Andreas PEIKER, Friedrichsdorf (DE); Lutz RICHTER, Mixdorf (DE); Christoph SCHILLO, Friedrichsdorf (DE)

(73) Assignee: Peiker Holding GmbH, Bad Homburg (DE)

(21) Appl. No.: 16/851,367

(22) Filed: Apr. 17, 2020

Related U.S. Application Data
(63) Continuation of application No. PCT/EP2018/078155, filed on Oct. 16, 2018.

(30) Foreign Application Priority Data
Oct. 20, 2017 (DE) 10 2017 124 604.5

(51) Int. Cl. H04W 4/06; H04W 4/029

(52) U.S. Cl. CPC H04W 4/06; H04W 4/029

(57) ABSTRACT

Group communication system comprising at least three communication devices, preferably a multiplicity of communication devices, wherein the communication devices communicate in at least one radio network directly, without the interposition of a static transmitting/receiving station, wherein each communication device provides a communication channel at least for the transmission of a sound, in particular voice, signal, wherein each communication device comprises at least one sensor for capturing data, in particular a motion sensor and/or temperature sensor and/or a tactile sensor and/or . . . , and provides a data channel for transmitting sensor data and/or signals on the basis of sensor data.

### CROSS REFERENCE TO RELATED APPLICATIONS

This application is a continuation of International Application No. PCT/EP2018/078155 filed Oct. 16, 2018, which designated the United States, and claims the benefit under 35 USC § 119(a)-(d) of German Application No. 10 2017 124 604.5 filed Oct. 20, 2017, the entireties of which are incorporated herein by reference.

### FIELD OF THE INVENTION

The present invention relates to a group communication system and method for operating a group communication system.

### BACKGROUND OF THE INVENTION

DE 10 2015 122 081 A1 discloses a group communication system (GKS).

Group communication systems are used in a large number of fields, for example within the realm of industry, sport or security. Of great relevance, and the subject of further inventions, is the ability for a multiplicity of communication devices to communicate within a group communication system directly, without the interposition of a static transmitting or receiving station. It is important in this case for the communication devices to have bidirectional communication channels, so that, in case of doubt, each subscriber is able to speak to and simultaneously hear any other subscriber, or multiple or all subscribers are able to speak to and simultaneously hear one another at the same time, for example, in the style of a conference call. Reference is hereby made to the parallel application with the file reference DE 10 2017 124 553, and the disclosure is incorporated into the disclosed content of this application by way of reference.

A disadvantage of known group communication systems is that the information conveyed is limited to sound signals. In this respect, further signal types often require additional devices or, in particular, also additional communication services, in particular, network services.

### SUMMARY OF THE INVENTION

It is, therefore, an object of the present invention to develop group communication systems in order to make them more universally usable.

The group communication system according to the present invention comprises at least three communication devices, preferably a multiplicity of communication devices, wherein the communication devices can communicate in at least one radio network directly, i.e. without the interposition of a static transmitting/receiving station. The avoidance of corresponding static transmitting/receiving stations allows independent use of the group communication system without the need for network coverage, for example, by a telecommunications provider, to be heeded.

The present invention is characterized in that each communication device comprises at least one sensor for capturing data, in particular, a motion sensor and/or a temperature sensor and/or tactile sensor or other sensors (e.g. pressure, moisture, brightness, etc.), and provides a data channel for transmitting sensor data and/or signals on the basis of the sensor data.

Sensor data can provide a multiplicity of options for how to improve the purposes of the group communication systems. As such, for example, a motion sensor can establish whether the carrier of a communication device is moving, or whether he has stopped moving on account of an accident, for example. Combinations of sensors are also conceivable, for example, in order to make detectable events clearer by means of combined queries for different sensor values before data are provided via a data channel. As an example, it is also possible to mention here the accident in which no further movement, at least of the type made beforehand, takes place and e.g an emergency button is touched. A further multiplicity of combined sensor queries or redundant querying of multiple sensors is also conceivable.

In a preferred embodiment of the group communication system, there is provision for each communication device to have a GPS receiver.

The incorporation of a GPS receiver, a person skilled in the art also being familiar with using other, possibly future, locating systems for position determination, renders any communication device capable of determining its position in the group communication system absolutely or relatively in relation to the other communication devices and of making the position available via the data channel. This allows e.g. transgressions of maximum ranges to be avoided or problems concerning group consolidation to be solved.

In a moreover preferred embodiment, there is provision for an optical sensor, in particular, a video camera, and/or an interface for an optical sensor, in particular, for a camera, to be comprised.

Both in the leisure realm and in the realm of security, it is often necessary to provide not only the open speaking and listening channel but also a visual transmission of signals. This allows conflicts, in particular, in the security realm, to be better detected, documented, rated and if necessary avoided.

In a further preferred embodiment, there is moreover provision for the data channel to provide a continuous data stream to at least one further communication device, in particular, to multiple communication devices, at least intermittently.

A continuous data stream permits a transmission of data in real time, so that events are immediately communicated and, if necessary, made available, and provided for reaction, by other subscribers in the group by using the group communication system.

In a further embodiment, there is moreover provision for at least one communication device to have a mobile network device, in particular, an access to the mobile Internet, wherein this communication device uses the data channel to provide the access for the other communication devices in the group communication system as access to the mobile Internet.

The operation of a mobile access point for the Internet and the provision thereof in the group communication system by means of a type of router function permits the group communication system to connect to larger networks. It is, therefore, possible, e.g. in the leisure realm, to upload information to portals or, in the industrial and security realm, to transmit external information to the user group of the group communication system. The option for multiple communication devices to comprise a mobile network device renders a type of nomadic access point realizable, so that the communication device that has the best reception can always operate as router in the group communication system.

The present invention moreover relates to a method for operating a group communication system, wherein the group communication system comprises a multiplicity of communication devices. According to the present invention, the method is characterized in that the communication devices perform a voice recognition to open at least one communication channel to at least one further communication device. Voice recognition is intended to be understood here to mean not a simple level measurement in the form of opening the channel when a volume level is exceeded, but rather an actual recognition of a voice command that then identifies a further communication device or an address of a further communication device and subsequently opens a communication channel to that device or to multiple devices, depending on which voice command is associated with which devices or device groups. Exemplarily, the devices can be personalized and addressed by giving the name of the using person. Groups of devices can then be addressed using group names such as “All” or “Group1”.

This allows the group communication system to be operated hands-free, as it is called, without all communication channels needing to be permanently open. A “push to talk” function known in the art is used to provide a “request to talk” function.

In a development of the method, there is moreover provision for prioritized data channels, via which a communication device is connected to at least one further communication device permanently, to be prescribed. This allows chains of communication devices to be connected, the transmission of data by which is ensured, since the permanent connection of the data channel is more particularly monitorable.

In a further preferred embodiment, there is provision for the group communication system GKS to be able to comprise a plurality of subgroups GKS-I and GKS-II, wherein the subgroups provide some, in particular all, functions of the group communication system GKS among one another.

The formation of subgroups allows action groups, e.g. in the scenario of an emergency response, to be consolidated that then communicate among one another in the spirit of the group communication system or that are addressed across groups and can communicate bidirectionally.

In a further embodiment, there is provision for the group communication system to have an interface to an external network, in particular, to the Internet, wherein the interface is produced by at least one communication device K1 to Kz (“z” representing a number for identifying the number of the communication device) and wherein the group communication system and/or further single and/or further multiple communication devices can be addressed by means of the interface.

The accessibility from an external network allows the group communication system to be called and contacted via the interface, e.g from the Internet. It is either possible for communications to be transmitted to the whole group communication system, or only individual communication devices or subgroups of multiple communication devices are addressed. In particular in a security or emergency scenario, it is, therefore, possible for a connection e.g. between a control center and a group communication system to be made at the place of use, wherein e.g. in order to call together or coordinate groups or subgroups.

In the special case in which the communication devices have means for position detection in the exterior or interior, e.g as a result of GPS or triangulation of the communication devices among one another, a communication channel can be opened and a position conveyed in the case of an emergency by operating a pushbutton switch (panic button).

In particular in the event of action in rescue scenarios or security scenarios, a communication device of the group communication system can be kept e.g. in a vehicle, in particular, can be kept in an action coordination vehicle, in order thus to coordinate the action groups by means of the communication.

Moreover, communication channels stored in a memory on the communication device can be automatically selected e.g in the event of an emergency call or an action scenario, and information of the individual communication devices can be transmitted via the data channel.

The group communication system according to the present invention will be explained in more detail in the exemplary embodiment that follows.

### BRIEF DESCRIPTION OF THE DRAWING

FIG. shows a group communication system according to the present invention.

### DETAILED DESCRIPTION OF THE INVENTION

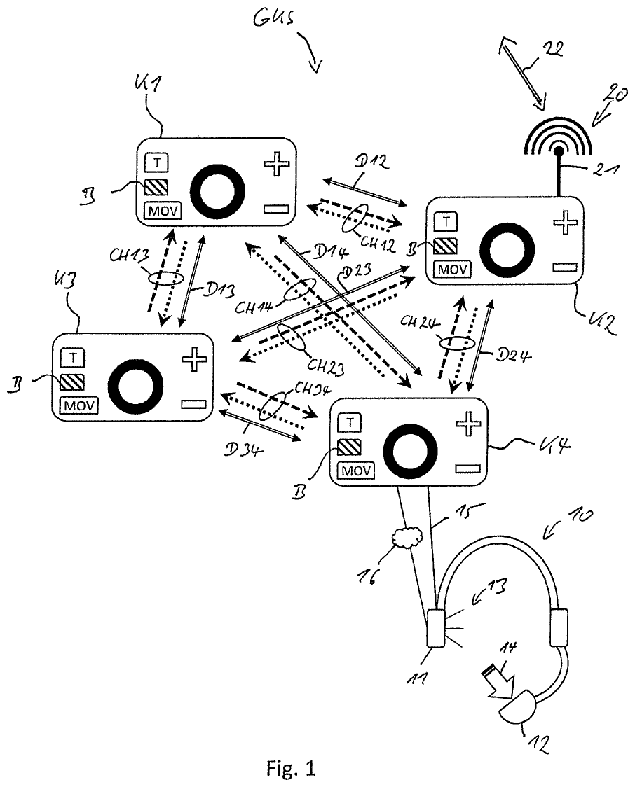

FIG. 1 shows a group communication system GKS having a total of four communication devices K1, K2, K3, K4. Exemplarily, a number of 3 sensors is depicted on the communication device K1, with a temperature sensor T, a motion sensor MOV and a tactile sensor B being shown. A multiplicity of further sensors are conceivable, as described in the general part, these also being able to the integrated invisibly in the housing.

Each communication device K1 to K4 has direct communication available with all other devices, each communication channel being in the form of a bidirectional communication channel. By way of example, the communication device K1 communicates with the communication device K2 via the channel CH12 directly, so that, for example, speaking and listening connections can take place at the same time. Furthermore, the communication device K2 communicates with the communication device K3 via the communication channel CH23 and the communication device K1 communicates with the communication device K3 via the communication channel CH13. The other communication devices K1-K4 communicate among one another via the depicted communication channels accordingly.

A headset 10 in the form of headphones with a microphone is depicted on the communication device K4 exemplarily. The headset 10 comprises headphones 11 and a microphone 12, the audio reproduction 13 being effected using the headphones and the audio recording 14 being effected using the microphone. The headset 10 can be connected to the communication devices K1 to K4 either via a wired connection 15 or via a wireless connection 16, for example, a Bluetooth connection. The headset can be used to record the voice and perform the described voice recognition in a defined manner.

Besides the communication channels CHXY, there is provision for additional data channels DXY. “X” and “Y” denote the numbers of the communication devices K1 to K4 communicating with one another. Reference is made to the description of the functions of the sensor data in the general part.

Exemplarily, a network device 20, in particular, a mobile Internet access, e.g LTE or subsequent generations of the mobile Internet, is depicted on the communication device K2. The data channel D12 or D24 or D23 can, therefore, be used by any other communication device to access this function.

All the communication devices K1 to Kz (z representing a number for identifying the communication devices) are connected to one another via radio connections, the radio connections being provided by other communication devices either directly or via the applicable functionalities.

The interface 20 to an external network, in particular, the Internet, which interface is depicted on the communication device K2, allows the group communication system to be addressed from outside. In the present case, the interface is in the form of a wireless interface with an antenna 21, which e.g. uses a mobile Internet standard, in particular, LTE or further standards, to access the Internet. In this way, signals 22 can be sent to the Internet and calls can be received from the Internet. Data connections of any type are also additionally conceivable.

1. A group communication system comprising at least three communication devices, preferably a multiplicity of communication devices,
wherein the communication devices communicate in at least one radio network directly, without the interposition of a static transmitting/receiving station,
wherein each communication device provides a communication channel at least for the transmission of a sound, in particular voice, signal,
wherein each communication device comprises at least one sensor for capturing data, in particular a motion sensor and/or temperature sensor and/or a tactile sensor and provides a data channel for transmitting sensor data and/or signals on the basis of sensor data.

2. The GKS as claimed in claim 1, wherein each communication device has a GPS receiver.

3. The GKS as claimed in claim 1, further comprises an optical sensor, in particular a video camera, and/or an interface for a camera is comprised.

4. The GKS as claimed in claim 1, wherein the data channel provides a continuous data stream to at least one further communication device, in particular to multiple communication devices, at least intermittently.

5. The GKS as claimed in claim 1, wherein at least one communication device has a mobile network device, in particular an access to the mobile Internet, wherein this communication device uses the data channel to provide an access for the other communication devices in the GKS as access to the mobile Internet.

6. A method for operating a group communication system, wherein the GKS comprises at least 3, preferably a multiplicity of, communication devices (K1 to Kz), wherein the communication devices perform a voice recognition to open at least one communication channel to at least one further communication device.

7. The method as claimed in claim 6, wherein at least one communication device is connected to at least one further communication device permanently via at least one data channel.

8. The method as claimed in claim 6, wherein the group communication system GKS can comprise a plurality of subgroups GKS-I and GKS-II, wherein the subgroups provide some, in particular all, functions of the group communication system GKS among one another.

9. The method as claimed in claim 6, wherein the group communication system has an interface to an external network, in particular to the Internet, wherein the interface is produced by at least one communication device K1 to Kz and wherein the group communication system and/or further single and/or further multiple communication devices can be addressed by means of the interface.
